(19) United States
(12) Patent Application Publication
(10) Pub. No.: US 2002/0017517 A1
(43) Pub. Date: Feb. 14, 2002

(54) Detachable temperature controller

(75) Inventor: Lugee Li, Dongguan City (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Dongguan Eande Electrical Products Co. Ltd., Dongguan City (CN)

(21) Appl. No.: 09/923,699

(22) Filed: Aug. 7, 2001

(30) Foreign Application Priority Data
Aug. 8, 2000 (CN) 00246957 .X

(51) Int. Cl. H05B 1/02

(52) U.S. Cl. 219/494; 219/490

(57) ABSTRACT

This invention relates to the new detachable temperature controller, which has a very important characteristic. If there is the force to draw it, the switch can be separated from the magnetic socket to ensure the safety of the electrical appliance. The temperature controller fits the common electrical appliances in the marketing. It consists of two parts, one is the switch to control the temperature, the other is the magnetic socket to connect the power. This kind of connecting method is the focus in this invention.

### BACKGROUND OF THE INVENTION

1. Field of the invention

This invention relates to the detachable temperature controller. Nowadays there are some disadvantage of the common electrical appliances in the marketing .If there is a force to draw it , the electrical appliance will be fallen down or inclined ;the wire and the connecting parts with electrical appliances will be injured. Meanwhile something dangerous will take place, such as the electric shock and leakage. In order to avoid this phenomenon, we invent this kind of new detachable temperature controller.

2. Prior Art Statement

This is the new detachable temperature controller, which has a very important characteristic. If there is the force to draw it, the sensor switch can be separated from the magnetic socket to ensure it safe. And the force requirement: when you draw it horizontally, the force must be 2-5 kg because we have to ensure the switch and magnetic socket connected tightly and this force is proper to user ;when you draw it at over 15 degree, the force will be under 0.8 kg to separate the sensor switch from magnetic socket easily.

### SUMMARY OF THE INVENTION

It is an object of this invention to provide a new, convenient, safe, ideal detachable temperature control that can overcome the lack of the prior known temperature regulating control units to comply with the common electrical appliances. This kind of connecting method can be generalized to ensure the electrical appliances safe ,not only the switch to control the temperature and the magnetic socket ,but also the switch to control the time or other kinds of switch and the magnetic socket.

This temperature controller is the improved products. It consists of two parts, one is the sensor switch to control the temperature, the other is the magnetic socket to connect the power. The described switch includes the temperature controller housing 4, the sensor switches 1 to control circuit and plug 3 to connect the electrical appliance ,a couple of power terminals 6 to conduct the magnetic socket power to the switch .The magnetic socket includes magnetic socket housing 16, two power inlet contact blade 8 and the permanent magnet 9 to input the magnetic socket housing 16, magnetic-iron sheet 7 to make the magnetic circuit back. There is the difference between the traditional temperature controller and the new temperature controller. The new temperature control part is separated from the power parts and they are connected by the magnet. If there is the force to draw it, the sensor switch can be separated from the magnetic socket in order to ensure it safe.

Please find the further information with reference to the following drawing:

### BRIEF DESCRIPTION OF THE DRAWING

FIG. 1 is a schematic entire view of the detachable temperature controller;

FIG. 2(a), (b) is the fragmentary view of the temperature control unit and the magnetic socket parts;

FIG. 3(a),(b) is the internal structure of FIG. 2;

FIG. 4 is the internal structure after two parts connection.

### DESCRIPTION OF THE PREFERRED EMBODIMENT

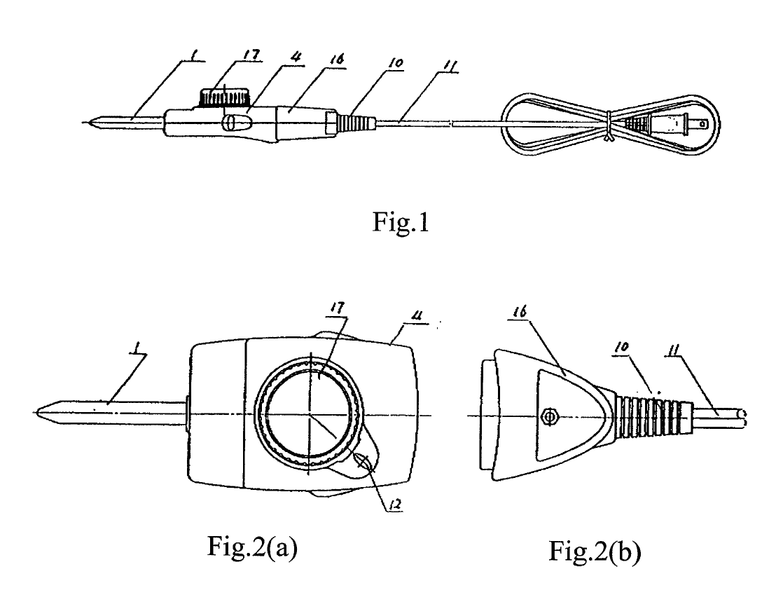

Refer to FIG. 1,FIG. 2(a),(b),the new temperature controller includes the switch to control the temperature and the magnetic socket to control the power. There are the following parts in details: the sensor switch 1, the temperature controlling housing 4, the temperature adjustment controls 17 of sensor switch 1,indication lamp 12,magnetic socket housing 16,rubber bushing 10 and power cord 11 and so on.

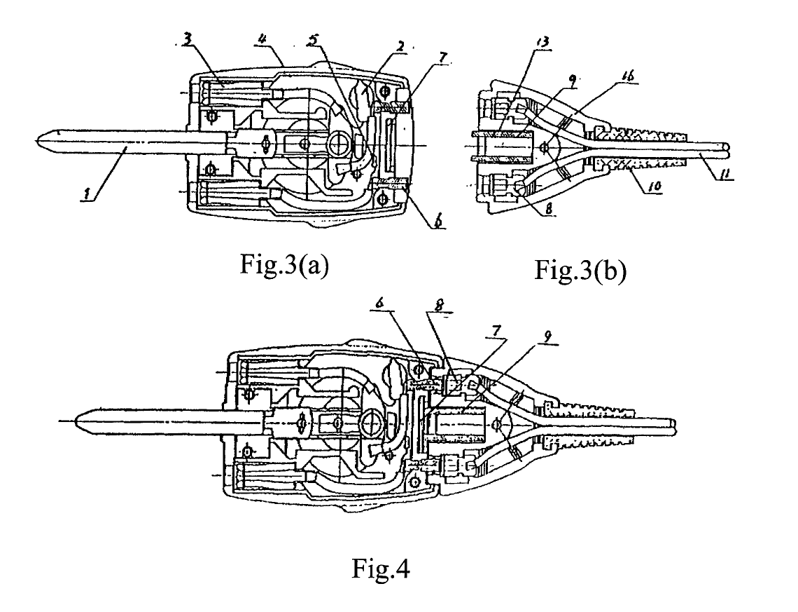

In the internal structure of FIG. 3(a), (b), the sensor switch 1 input the middle of the temperature controlling housing 4; there is plug 3 in the sensor switch 1 to connect the electrical appliance. What's more, a couple of electrical contact 6 and iron sheet 7 input the terminal of temperature housing 4 to connect the magnetic socket . In the sensor switch there is a neon lamp 2 and resistor 5 to indicate the power on/off. The other magnetic socket parts includes: a couple of power inlet contact blade 8 and the permanent magnetic-iron 9 to input the magnetic socket housing 16.

FIG. 4 is the internal structure after the two parts connection. When two parts are connected , the permanent magnetic-iron 9 will connect the iron sheet 7 through the magnetic circle 13 so that a couple of electrical contact 6 will connect the power inlet contact blade 8. In this way, it makes the power back/open .The magnetic circle 13 is oxygenated iron sheet which conduct the magnetic produced by the permanent magnetic-iron

When using, we connect the temperature controller with the electrical appliance, then turn the temperature controller button to the desired temperature, then plug the power cord into the socket ,then indication lamp will be on . When heating to the desired temperature, the terminal of sensor switch will cut the power. When the temperature is lower than the desired temperature, the contact point of sensor switch will be back automatically, the power will continue heating. In this way we can achieve the purpose of the temperature controller's circulation. If there is the force to draw it, its sensor switch will be separated from the magnetic socket to cut the power to ensure the electrical appliance safe. In this way, the power contact blade will be not nude so something dangerous won't take place, such as the electric shock, leakage incidents.

In this new invention there is the focus that the sensor switch to control the temperature connect the magnetic socket to control the power through the magnetic . If there is the force to draw it, the sensor switch can be separated from the magnetic socket in order to ensure the safety of the electrical appliance.

What we claim for:

1. The detachable temperature controller, Which consists of two parts, one is the sensor switch to control the temperature, the other is the magnetic socket to connect the power, They are connected by the permanent magnet.

2. The detachable temperature controller according to claim1, where in: The permanent magnetic-iron produces the magnetic to conduct through the described magnetic-iron. In this way, the switch to control the temperature can connect the magnetic socket to control the power.

3. The detachable temperature controller according to claim 1, where in: The conducted magnetic material is oxygenated iron.
